(19) United States
(12) Patent Application Publication
(10) Pub. No.: US 2024/0345731 A1
(43) Pub. Date: Oct. 17, 2024

(54) DYNAMIC WRITE SPEEDS FOR DATA PROGRAMMING

(71) Applicant: Micron Technology, Inc., Boise, ID (US)

(72) Inventors: Jameer Mulani, Bangalore (IN); Amiya Banerjee, Bangalore (IN)

(21) Appl. No.: 18/603,031

(22) Filed: Mar. 12, 2024

Related U.S. Application Data
(60) Provisional application No. 63/495,804, filed on Apr. 13, 2023.

(51) Int. Cl. G06F 3/06

(52) U.S. Cl. CPC G06F 3/0611; G06F 3/0659; G06F 3/0679

(57) ABSTRACT

Methods, systems, and devices for dynamic write speeds for data programming are described. A memory system controller may transfer first data from a first portion of a memory system to a second portion of the memory system according to a first set of parameters based on determining that a first quantity of unavailable data blocks of the first portion satisfies a first threshold. The memory system controller may receive one or more commands to write second data and may write the second data to one or more data blocks of the first portion. The memory system controller may transfer third data from the first portion to the second portion according to a second set of parameters and based on determining that a second quantity of unavailable data blocks of the first portion (and based on writing the second data) satisfies a second threshold.

### CROSS REFERENCE

The present application for patent claims the benefit of U.S. Provisional Patent Application No. 63/495,804 by MULANI et al., entitled “DYNAMIC WRITE SPEEDS FOR DATA PROGRAMMING,” filed Apr. 13, 2023, assigned to the assignee hereof, and expressly incorporated by reference herein.

### TECHNICAL FIELD

The following relates to one or more systems for memory, including dynamic write speeds for data programming.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports dynamic write speeds for data programming in accordance with examples as disclosed herein.

FIG. 2 illustrates an example of a system that supports dynamic write speeds for data programming in accordance with examples as disclosed herein.

FIG. 3 illustrates an example of a data transfer diagram that supports dynamic write speeds for data programming in accordance with examples as disclosed herein.

FIG. 4 illustrates an example of a process flow that supports dynamic write speeds for data programming in accordance with examples as disclosed herein.

FIG. 5 illustrates an example of a process flow that supports dynamic write speeds for data programming in accordance with examples as disclosed herein.

FIG. 6 illustrates a block diagram of a memory system that supports dynamic write speeds for data programming in accordance with examples as disclosed herein.

FIG. 7 illustrates a flowchart showing a method or methods that support dynamic write speeds for data programming in accordance with examples as disclosed herein.

### DETAILED DESCRIPTION

A memory system may perform one or more access operations. For example, the memory system may receive one or more commands (e.g., via a controller of the memory system) and may write data to memory cells at a lower storage density (e.g., memory cells may be configured at a time as single level cells (SLCs), multi-level cells (MLCs), tri-level cells (TLCs), or quad-level cells (QLCs)) of one or more data blocks in response to the one or more commands. Additionally, the memory system may free up one or more written-to data blocks for further write operations by transferring (e.g., as part of a folding or garbage collection operation) data to memory cells, of additional data blocks, at a higher storage density (e.g., QLCs), and performing an erase operation on the previously written-to data blocks. Thus, by transferring and storing data at a higher storage density from memory cells with data stored at a lower storage density, the memory system may free up one or more data blocks for further host writes or other operations while consolidating information to improve storage efficiency. However, a write speed (e.g., programming speed) for higher storage density operations may be slower than a write speed of lower storage density operations, which may delay one or more host writes and result in higher latency of write operations, as well as result in a slower throughput of folding operations. In some cases, a memory system may implement a faster write speed for higher storage density operations, but using a faster write speed may compromise data integrity (e.g., may result in invalid written data) in one or more memory cells.

To mitigate high latency during host writes and low throughput during folding, as well as maintain an integrity of data stored in the memory system, the memory system may implement different write speeds dynamically during transfer operations. For example, a controller of the memory system may write data, in response to receiving one or more commands from a host system, to one or more data blocks of a first portion of the memory system. These host write operations may be written using a first, lower storage density. The controller may determine that a first quantity of unavailable data blocks of the first portion (e.g., data blocks containing valid data) satisfies a first threshold, and in response to the determining, the controller may begin transferring data from the first portion to the second portion using a first set of parameters associated with a first write speed. During the transfer of the data, the controller may continue to perform additional host write operations to the first portion which may continue to fill up one or more data blocks of the first portion due to the slower speed of the folding compared to the host writes. Thus, a second, higher threshold of unavailable source data blocks of the first portion may be reached. In response to determining that a second quantity of unavailable data blocks of the first portion satisfies a second, higher threshold, the controller may switch to transferring data using a second set of parameters associated with a second write speed that is faster than the first write speed. In some cases, the controller may store one or more bits (e.g., flags) indicating which data blocks were programmed to using the second set of parameters. During idle time, the controller may prioritize refreshing the flagged memory cells.

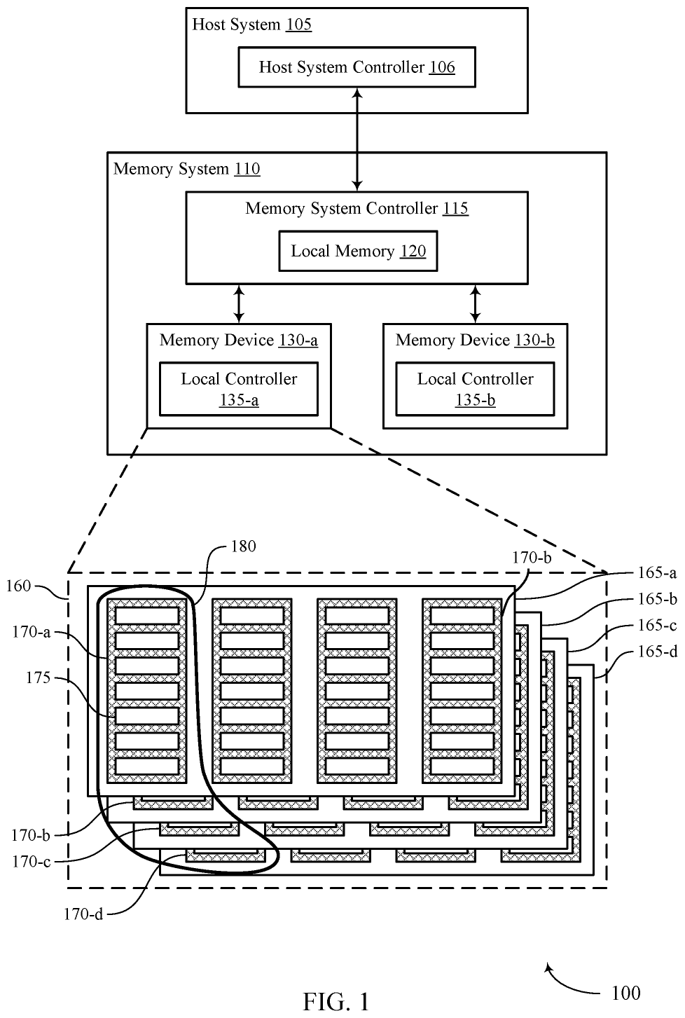

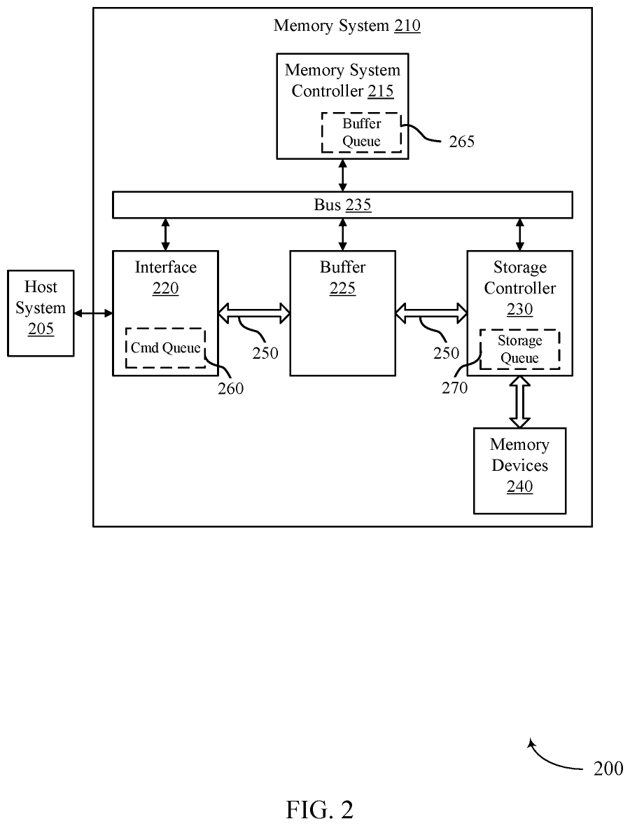

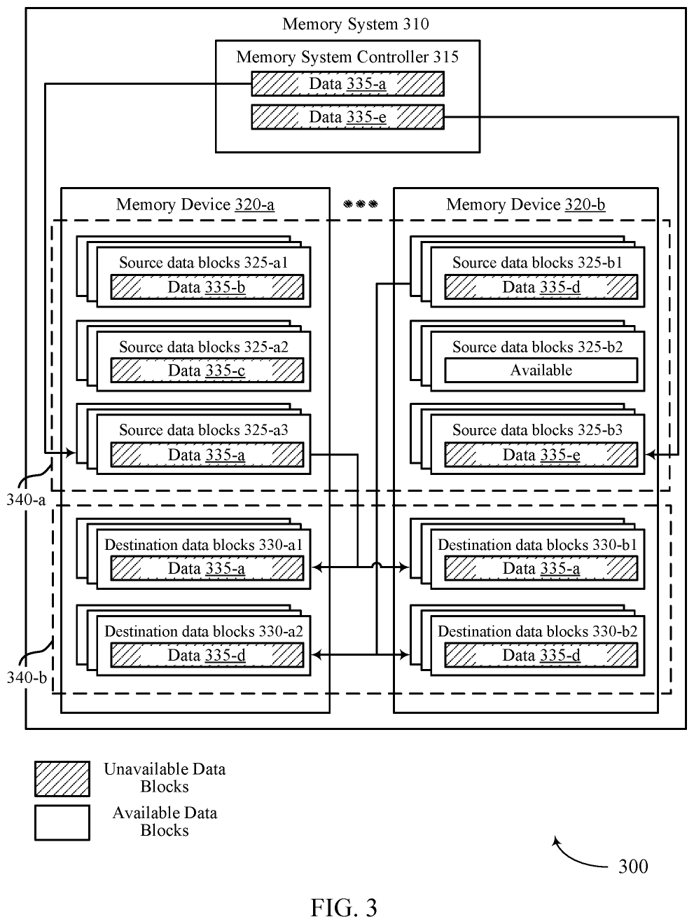

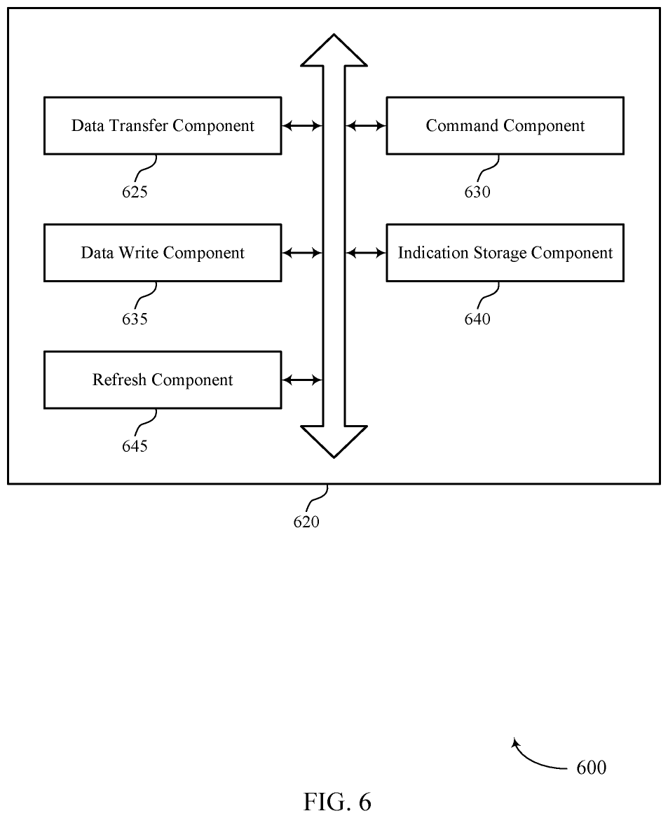

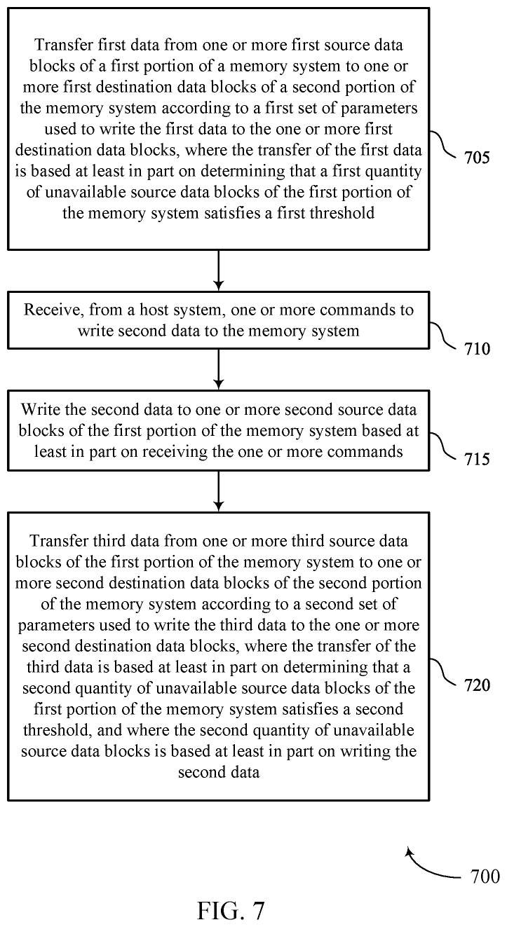

Features of the disclosure are initially described in the context of systems, devices, and circuits with reference to FIGS. 1 through 2. Features of the disclosure are described in the context of data flow diagrams and process flows with reference to FIGS. 3-5. These and other features of the disclosure are further illustrated by and described in the context of an apparatus diagram and flowchart that relate to dynamic write speeds for data programming with reference to FIGS. 6 and 7.

FIG. 1 illustrates an example of a system 100 that supports dynamic write speeds for data programming in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically crasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The system 100 may include any quantity of non-transitory computer readable media that support dynamic write speeds for data programming. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some examples, to mitigate high latency during host writes and low throughput during folding, as well as maintain an integrity of data stored in the memory system 110 (e.g., within the blocks 170 of the memory devices 130), the memory system 110 may implement different write speeds dynamically during transfer operations. For example, the memory system controller 115 may write data, in response to receiving one or more commands from the host system 105, to one or more data blocks (e.g., blocks 170) of a first portion of the memory system 100. The data may be written at a first, lower storage density, where the first portion may include data blocks of one or more of the memory devices 130 (e.g., of a TLC buffer). The memory system controller 115 may determine that a first quantity of unavailable data blocks of the first portion (e.g., blocks 170 containing valid data within one or more pages 175) satisfies a first threshold, and may begin transferring data (e.g., folding as part of a garbage collection operation) from the first portion to a second portion of the memory system using a first set of parameters associated with a first write speed. The second portion may include one or more additional data blocks of the one or more memory devices 130 (e.g., QLC storage), where the transfer of the data may writing data from the first portion to the second portion at a second, higher, storage density. While performing the transfer of the data, the memory system controller 115 may continue to perform additional host write operations to the first portion at the first, lower storage density, which may continue to fill up one or more data blocks of the first portion due to the slower speed of the folding compared to the host writes. Thus, in response to determining that a second quantity of unavailable data blocks of the first portion satisfies a second, higher threshold, the memory system controller 115 may begin to transfer data using a second set of parameters associated with a second write speed that is faster than the first write speed.

FIG. 2 illustrates an example of a system 200 that supports dynamic write speeds for data programming in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

In some examples, to mitigate high latency during host writes and low throughput during folding, as well as maintain an integrity of data stored in the memory system 210 (e.g., within the memory devices 240), the memory system 210 may implement different write speeds dynamically during transfer operations. For example, the memory system controller 215 may receive one or more commands, from the host system 205, to write data and may store the commands in the buffer queue 265 and the data in the buffer 225. The memory system controller 215 may write the data to a first portion of the memory system 210 using a first, lower storage density, where the first portion may include data blocks of one or more memory devices 240. The memory system controller 215 may determine that a first quantity of unavailable data blocks of the first portion satisfies a first threshold, and in response to the determining, may begin transferring data (e.g., via the storage queue 270) using a first set of parameters associated with a first write speed. For example, the memory system controller 215 may write data from the first portion to a second portion of the one or more memory devices 240 using a second storage density higher than the first storage density. While performing the transfer of the data, the memory system controller 115 may continue to perform additional host write operations to the first portion at the first, lower, storage density, which may continue to fill up one or more data blocks of the first portion due to the slower speed of the folding to the second portion compared to the host writes to the first portion. Thus, in response to determining that a second quantity of unavailable data blocks of the first portion satisfies a second, higher threshold, the memory system controller 115 may begin to transfer data using a second set of parameters associated with a second write speed that is faster than the first write speed.

FIG. 3 illustrates an example of a data transfer diagram 300 that supports dynamic write speeds for data programming in accordance with examples as disclosed herein. The data transfer diagram 300 may illustrate operations of one or more components of a system 100 or a system 200 as described with reference to FIGS. 1 and 2. For example, the data transfer diagram 300 may illustrate a memory system 310 including a memory system controller 315 and one or more memory devices 320, which may represent the memory systems 110 or 210, the memory system controllers 115 or 215, and the memory devices 130 or 240, respectively, described with reference to FIGS. 1 and 2. The memory system 310 may include memory devices 320-a through 320-b, which may represent any quantity of memory devices 320. Each memory device 320 may represent a die, such as a die 160 as described with reference to FIG. 1, where the memory system 310 may be operable to perform single-die and/or multi-die operations across the memory devices (e.g., dies) 320-a through 320-b. In some examples, the memory system 310 may implement different write speeds dynamically during data programming operations to decrease latency and increase throughput of one or more operations while maintaining data integrity as described herein.

Each memory device 320 may include one or more source data blocks 325 and one or more destination data blocks 330, where source data blocks 325 and destination data blocks 330 may represent examples of blocks 170 as described with reference to FIG. 3. For example, the memory device 320-a may include source data blocks 325-a1, 325-a2, and 325-a3 as well as destination data blocks 330-a1 and 330-a2, and the memory device 320-b may include source data blocks 325-b1, 325-b2, and 325-b3 as well as destination data blocks 330-b1 and 330-b2, among other source data blocks 325 and destination data blocks 330. Each of the source data blocks 325 may be operable to store data 335 in one or more pages (e.g., pages 175). In some examples, a source data block 325 may represent a destination data block 330, or vice versa, depending on how the source data block 325 or the destination data block 330 is used during one or more access or transfer operations. For example, a source data block 325 may be a data block from which data is transferred as part of a folding operation, and a destination data block 330 may be a data block to which data is transferred as part of a folding operation.

In some cases, the source data blocks 325 and the destination data blocks 330 may include SLCs, MLCs, TLCs, or QLCs, at a given time. That is, memory cells of a data block may be programmed as one type of memory cell at a first time and as a second type of memory cell at a second time (e.g., after erasure of the data block). Writing to memory cells at lower storage densities (e.g., memory cells storing fewer bits per memory cell, such as SLCs, MLCs, and TLCs) may be associated with a faster write time, or program time (e.g., TPROG with a faster write speed), compared to writing to memory cells at higher storage densities (e.g., QLCs). For example, performing one-bit or three-bit programming operations (e.g., to SLCs and TLCs) may have a TPROG of approximately 60 us and 300 us per bit, respectively, whereas programming using a quad-bit or quad-level operation (e.g., to QLCs) may have a TPROG of approximately 1200 μs per bit, or longer. In some cases, writing to QLCs may include two-pass programming. For example, two-pass programming may include performing two sets of relatively small (e.g., smaller width or amplitude) programming pulses, instead of a single set of relatively large programming pulses, to accurately program one or more QLCs and avoid program disturb. The source data blocks 325 (e.g., data blocks to which data is written) may include memory cells written to at a lower storage density (e.g., SLCs, MLCs, or TLCs), which may allow faster writing to the source data blocks 325. The destination data blocks 330, alternatively, may include memory cells written to at a higher storage density (e.g., QLCs) to enable compact information storage. In some examples, a source data block 325 may include memory cells written to at a higher storage density, for example, if previously functioning as a destination data block 330.

The data blocks may be part of one or more portions 340 of the memory system 310. For example, the memory system 310 may include a first portion 340-a, which may include source data blocks 325 across each of the memory devices 320-a through 320-b. Additionally, or alternatively, the memory system 310 may include a second portion 340-b, which may include destination data blocks 330 across the memory devices 320-a through 320-b. The first portion 340-a may represent an SLC buffer or a TLC buffer of the memory system 310 containing SLCs and TLCs, while the second portion 340-b may represent QLC storage containing QLCs. By way of another example, the first portion 340-a, the second portion 340-b, or both, may include a combination of source data blocks 325 and destination data blocks 330 across any combination of memory devices 320. In some cases, the portions 340 may be examples of one or more virtual blocks 180 as described with reference to FIG. 1.

In some examples, the memory system 310 may perform one or more access (e.g., write) operations in response to one or more commands received from a host system, such as a host system 105 or 205 as described with reference to FIGS. 1 and 2. For example, the memory system controller 315 may receive one or more commands from a host system 205 to write first data, such as the data 335-a, and may store the commands (e.g., in a buffer queue 265) and the data 335-a (e.g., in the buffer 225). In response to the one or more commands, the memory system controller 215 may write the data 335-a to the one or more source data blocks 325-a3. Similarly, the source data blocks 325-a1, 325-a2, and 325-b1 may contain data 335-b through data 335-d written in response to one or more previous commands received from the host system 205. Additionally, or alternatively, the data 335 may be written to SLCs (e.g., of the source data blocks 325-a3) in response to a WriteBooster command being enabled, or to TLCs (e.g., of different data blocks 325) in response to a WriteBooster command being disabled.

In some examples, the memory system 210 may determine to transfer (e.g., fold) data 335 from one or more of the source data blocks 325-a3 to one or more of the destination data blocks 330 as part of multi-level programming operations. For example, the memory system controller 315 may determine that an amount of unavailable source data blocks 325 of the first portion 340-a (e.g., TLC buffer) satisfies a first threshold quantity of unavailable source data blocks 325. In some cases, an unavailable source data block 325 may be a source data block 325 without available storage space, that is, having pages that have been written to or that contain valid data. For example, the source data blocks 325-a1 through 325-a3 and 325-b1 may represent groups of unavailable source data blocks due to the write operations described herein, where the source data blocks 325-b2 may represent available source data blocks. Additionally, satisfying a threshold may represent being equal to or greater than a threshold, whereas failing to satisfy a threshold may represent being less than a threshold. In an example, the memory system controller 315 may determine that the first portion 340-a satisfies the first threshold in response to detecting valid data 335 in the source data blocks 325-a1 through 325-a3 and 325-b1.

The memory system controller 215 may thus begin folding data 335 (e.g., initiate a transfer of the data 335, such as part of garbage collection) from data blocks of the first portion 340-a to data blocks of the second portion 340-b to free data blocks of the first portion 340-a. For example, the memory system controller may fold the data 335-a according to a first set of parameters associated with a first write speed, for example, with a TPROG of 1200 μs. In the example of FIG. 3, the memory system controller 315 may fold the data 335-a from the source data block 325-a3 to the destination data block 330-a1 (e.g., of the same memory device 320-a) or to the destination data block 330-b1 (e.g., of the different memory device 320-b). Additionally, or alternatively, the memory system controller 315 may fold any of the data (e.g., the data 335-b or the data 335-c). The folding operations may also be performed in response to determining a logical saturation of the memory system 310. For example, the memory system controller 315 may perform folding in response to determining that a first quantity of available (e.g., not yet programmed or freed) LBAs in a logical address space, such as an L2P mapping table as described with respect to FIG. 1, satisfies a first threshold quantity of available LBAs. In some cases, the folding operations may represent performing one or more operations (e.g., TRIM operations) during garbage collection as described herein with respect to FIG. 1.

In some examples of multi-level programming, the memory system controller 315 may perform a refresh operation on one or more data blocks to maintain or ensure an integrity of data 335 written to the data blocks. For example, after performing a garbage collection operation involving folding the data 335-a to the destination data blocks 330-a1, the memory system 310 may enter an idle period where the memory system controller 315 may not receive access commands from the host system 205. After detecting the idle period, for example, by determining a lapsed duration of time since a last access command, the memory system 310 (e.g., via the memory system controller 315) may perform a refresh operation of one or more data blocks. In some examples, a refresh operation may include transferring memory cells of one or more data blocks of the memory system 310 to additional memory blocks using the first write speed, to achieve a greater stability of charges stored in the memory cells.

In some examples, the first portion 340-a of the memory system 310 may continue to be written to after beginning folding operations. For example, the memory system controller 315 may continue to write data 335 to available source data blocks 325 in parallel with folding operations in response to additional commands received while folding. However, due to the relatively slow first write speed of the folding operations (e.g., with TPROG of 1200 μs), the first portion 340-a may continue to fill, where additional source data blocks 325 may become unavailable. For example, the memory system controller 315 may receive a large amount of successive write commands (e.g., as part of a large write operation, such as a phone cloning operation), and may continue to write to source data blocks 325 during folding, where data may not be folded fast enough to free additional source data blocks 325 for additional writes. In another example, a memory device 320 may not support folding concurrent with access operations, and thus host write operations may be limited by a number devices 320 available for host writes (e.g., not occupied with folding). Thus, the memory system controller 315 may begin to refrain from receiving additional commands from the host system 205, which may lead to delaying one or more host write operations. In some examples, the memory system 310 may implement a second set of parameters to implement a faster write speed for folding operations to avoid delaying host writes, but using a faster speed during write operations may compromise a data integrity of memory cells of the memory system 310. For example, by writing at a faster programming speed, a stored voltage in memory cells of the data blocks of the memory system 310 may be less stable, or more prone to read errors due to a smaller gap between cell states.

As described herein, the memory system 310 may implement different write speeds dynamically during data programming operations to decrease a latency and increase a throughput of one or more operations. For example, after beginning folding operations using the first set of parameters associated with the first write speed, the memory system 310 may receive one or more commands to write second data, such as the data 335-c, and may write the data 335-e to the one or more source data blocks 325-b3. The memory system 310 may determine that a second quantity of unavailable source data blocks 325 satisfies a second threshold greater than the first threshold in response to writing the data 335-e. For example, writing the data 335-e may increase a total amount of unavailable source data blocks 325 in the first portion 340-a to above the second threshold. In response to the second quantity satisfying the second threshold, the memory system controller 315 may begin to fold data using the second set of parameters associated with the second, faster write speed. For example, the memory system controller 315 may fold the data 335-d (or the data 335-c) to the destination data blocks 330-b2 (or 330-a2) using a TPROG of 700 μs per bit.

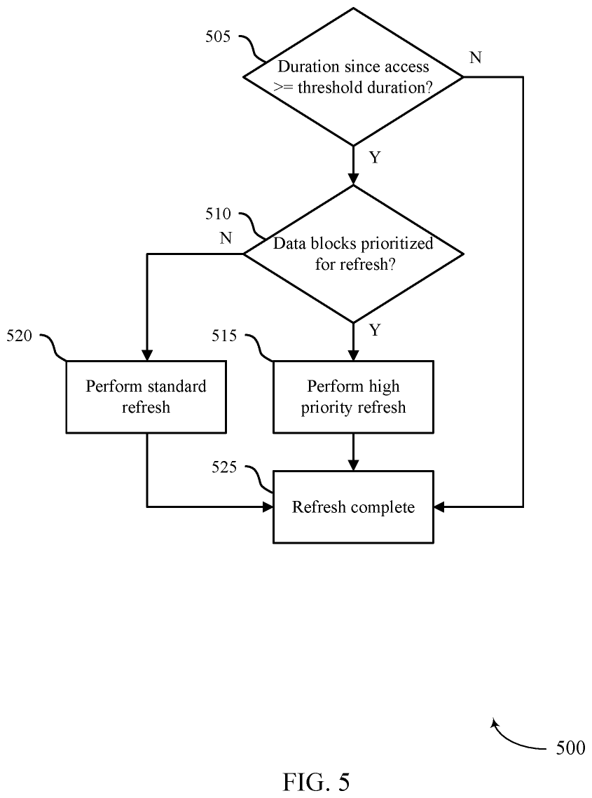

The memory system 310 may thus adjust a speed of operations using the first threshold and the second threshold. For example, the memory system controller 315 may continue folding operations and may free up one or more source data blocks 325, such as the source data blocks 325-b1, in response to using the second, faster write speed, which may bring a quantity of unavailable source data blocks 325 back below the second threshold. The memory system controller 315 may receive one or more commands to write third data and may write the third data to the freed source data blocks 325-b1 accordingly. The memory system controller 315 may determine that a third quantity of unavailable source data blocks 325 satisfies the first threshold, but fails to satisfy the second threshold, and may switch back to the first set of parameters for folding operations. Additionally, or alternatively, the memory system controller 315 may switch back to the first set of parameters by comparing the third quantity of unavailable source data blocks to a third threshold different from the second threshold or the first threshold, where the switch may be in response to the third quantity failing the satisfy the third threshold. For example, the memory system controller 315 may transfer fourth data from the first portion 340-a to one or more destination data blocks 330 of the second portion 340-b of the memory system 310 using the first write speed. Additionally, the memory system 310 may maintain an integrity of memory cells while writing using the second, faster speed, by flagging one or more memory cells for high priority refresh as described with reference to FIG. 5. For example, the memory system may flag the data 335-d for high priority refresh in response to writing the data 335-d using the second set of parameters to maintain integrity of the data 335-d.

In some examples, the second set of parameters include one or more changes to write (e.g., programming) operations to achieve the second write speed (e.g., TPROG=700 μs). For example, the second set of parameters may define pulse widths (e.g., of a voltage or current pulse) of two-pass programming pulses to increase or decrease a write speed (e.g., 1200 μs or 700 μs) compared to the first set of parameters. Additionally, or alternatively, the second set of parameters may define different pulse amplitudes, different quantities of pulses, characteristics of a first pulse, a second pulse, or both, among other characteristics of QLC programming operations.

In some examples, the memory system 310 may refrain from switching between the two sets of parameters (e.g., from switching write speeds) until a current block being written to is full. For example, the memory system controller 315 may be in the process of folding a portion of the data 335-d to a data block of the destination data blocks 330-b2 using the first set of parameters at a time that the memory system controller 315 determines that the second quantity of unavailable source data blocks 325 satisfies the second threshold. In response to the determination, the memory system controller 315 may continue writing the portion of the data 335-d to the block until a boundary of the block, and may begin writing the rest of the data 335-d to additional blocks of the destination data blocks 330-b2 using the second set of parameters (e.g., associated with the second write speed).

The first threshold and the second threshold may be associated with one or more percentages of logical saturation of the memory system 310. For example, the memory system controller 315 may begin folding in response to determining that a second quantity of available LBAs in a logical address space (e.g., L2P mapping table) corresponding to data written to the first portion of the memory system 310 satisfies a second, higher threshold of available LBAs. In an illustrative example, the second threshold may be associated with a 90% logical saturation, where a 90% logical saturation may represent 90% of the L2P table being filled. Subsequently, a majority of source data blocks 325 of the first portion 340-a may contain valid data when the second write speed is used. In some cases, the memory system 310 may include one or more overprovisioned blocks, where overprovisioned blocks may represent one or more additional blocks not known to the host system 205 and used when one or all of the portions 340 are full. For example, at a high logical saturation, the memory system 310 may perform folding using the second set of parameters while performing write operations to the one or more blocks including the overprovisioned blocks during the folding operations.

The operations described herein may improve a throughput of operations by enabling performing a large number of host writes and folding operations in parallel before the TLC buffer becomes full and GC is performed to free up blocks for additional host writes, or may result in continuous write operations without a need for dedicated time periods for folding operations. Further, utilizing dynamic write speeds based on different sets of parameters may decrease a latency (e.g., <1 ms) for smaller write operations (e.g., using the first set of parameters). Additionally, by prioritizing data blocks written to using the second set of parameters for refresh as described with respect to FIG. 5, a data integrity of memory cells may be maintained while using the faster write speed. In some examples, the methods described herein may improve throughput, latency, among other features in higher storage density programming as well, such as with penta-level cell (PLC) programming. The methods described herein may also improve a lifetime of a device.

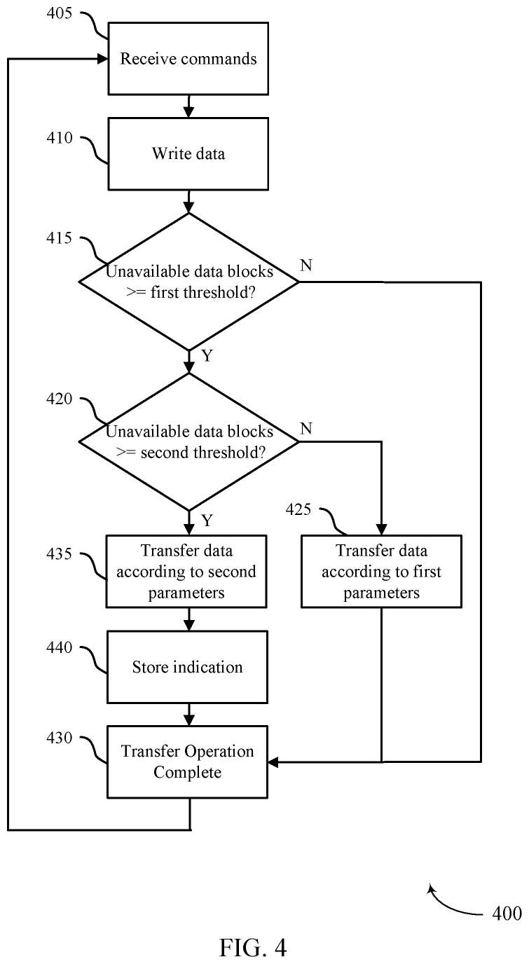

FIG. 4 illustrates an example of a process flow 400 that supports dynamic write speeds for data programming in accordance with examples as disclosed herein. For example, the process flow 400 may represent a data write and data folding process performed by the memory system controller 315 of the memory system 310 as described with reference to FIG. 3.

Aspects of the process flow 400 may be implemented by the memory system controller 315, among other components. Additionally, or alternatively, aspects of the process flow 400 may be implemented as instructions stored in memory (e.g., firmware stored in a memory coupled with the memory system controller 315). For example, the instructions, when executed by the memory system controller 315, may cause the controller to perform the operations of the process flow 400.

In some examples, the process flow 400 may represent performing folding operations according to a first set of parameters. For example, at 405, the memory system controller 315 may receive one or more commands to write first data (e.g., the data 335-a) to the memory system, and at 410, the memory system controller 315 may write the first data to one or more source data blocks (e.g., the source data blocks 325-a3) of a first portion (e.g., the portion 340-a) of the memory system 310. At 415, the memory system controller 315 may determine that a first quantity of unavailable source data blocks of the first portion satisfies (e.g., is greater than or equal to) a first threshold, and may proceed to 420, where the memory system controller 315 may determine that the first quantity fails to satisfy the second threshold. The memory system controller 315 may proceed to 425 to transfer the first data from one or more first source data blocks (e.g., the source data blocks 325-a3) to one or more first destination data blocks (e.g., the destination data blocks 330-a1 or 330-b1) of a second portion (e.g., the second portion 340-b) of the memory system 310. The memory system controller 315 may transfer the first data according to a first set of parameters used to write the first data to the one or more first destination data blocks (e.g., the first set of parameters associated with the first write speed). After transferring the first data, the memory system controller 315 may proceed to 430, and the transfer operation may be complete.

Additionally, or alternatively, the process flow 400 may represent performing folding operations according to the second set of parameters. For example, after writing the first data, the memory system controller 315 may proceed to 405 to receive one or more commands to write second data (e.g., the data 335-e) to the memory system 310, and may proceed to 410 to write the second data to one or more second source data blocks (e.g., the source data blocks 325-b3) of the first portion of the memory system in response to receiving the one or more commands. The memory system controller 315 may determine that a second quantity of unavailable source data blocks (e.g., determined at a later time) satisfies the first threshold at 415, as well as satisfies the second threshold at 420. In some examples, the second quantity of unavailable source data blocks may represent an increased size of the first quantity of unavailable source data blocks due to writing the second data. In response to the determination, the memory system controller 315 may proceed to 435 to transfer third data (e.g., the data 335-b, the data 335-a, or both) from one or more third source data blocks of the first portion of the memory system to one or more second destination data blocks (e.g., the destination data blocks 330-a2 or 330-b2) of the second portion of the memory system according to a second set of parameters used to write the third data to the one or more second destination data blocks (e.g., the second set of parameters associated with the second, faster write speed).

In some examples, after transferring the second data according to the second set of parameters, the memory system controller 315 may proceed to 440 to store one or more bits indicating that the third data was transferred to the one or more second destination data blocks according to the second set of parameters. For example, the memory system controller 315 may store the one or more bits within one or more blocks of the one or more second destination data blocks, or within another memory of the memory system 310, such as in an L2P mapping table. In some cases, the memory system controller 315 may store the bits to indicate, or flag, the blocks for high priority refresh as described with reference to FIG. 5. After storing the indication, the memory system controller 315 may proceed to 430, where the transfer operation may be complete.

In some examples, the process flow 400 may represent writing the additional data 335 according to the first set of parameters once unavailable source data blocks have fallen again below the second threshold (or a third threshold as described with reference to FIG. 3). For example, after performing one or more folding operations and/or write operations as described herein, the memory system controller 315 may determine that a third quantity of unavailable source data blocks of the first portion of the memory system satisfies the first threshold at 415 and fails to satisfy the second threshold (or the third threshold) at 420. In response to the determination, the memory system controller 315 may proceed to 425 to transfer, after the transfer of the third data, fourth data from one or more fourth source data blocks of the first portion of the memory system to one or more third destination data blocks of the second portion of the memory system according to the first set of parameters. In some examples, if a quantity of unavailable data blocks fails to satisfy the first threshold, the memory system controller 315 may refrain from performing transfer operations (e.g., folding or garbage collection operations) in response to the TLC buffer having sufficient room for writes, and may proceed to 430.

In some examples, writing the first data and the second data comprises programming the first data and the second data to the one or more first source data blocks and the one or more second source data blocks using a single bit (e.g., SLC), a dual bit (e.g., MLC), or a triple bit (e.g., TLC) programming operation. Additionally, transferring the first data to the one or more first destination data blocks and the third data to the one or more second destination data blocks may include programming the first data to the one or more first destination data blocks and the third data to the one or more second destination data blocks using a quad-level programming operation (e.g., QLC). In some examples, the first set of parameters may be associated with a first duration associated with writing each bit of the first data (e.g., TPROG of 1200 μs) and the second set of parameters may be associated with a second duration less than the first duration and associated with writing each bit of the third data (e.g., TPROG of 700 μs).

In some cases, determining that the first quantity of unavailable source data blocks satisfies the first threshold and determining that the second quantity of unavailable source data blocks satisfies the second threshold may include determining that a first quantity of valid source data blocks of the first portion of the memory system satisfies a first threshold quantity of valid source data blocks and that a second quantity of valid source data blocks of the first portion satisfies a second threshold quantity of valid source data blocks. For example, the first and second quantities of unavailable source data blocks may represent the first and second quantities of valid source data blocks, and the first and second threshold quantities of unavailable source data blocks may represent the first and second threshold quantities of valid source data blocks.

FIG. 5 illustrates an example of a process flow 500 that supports dynamic write speeds for data programming in accordance with examples as disclosed herein. For example, the process flow 500 may represent refreshing one or more data blocks of a memory system 310 as described with reference to FIG. 3.

Aspects of the process flow 500 may be implemented by the memory system controller 315, among other components. Additionally, or alternatively, aspects of the process flow 500 may be implemented as instructions stored in memory (e.g., firmware stored in a memory coupled with the memory system controller 315). For example, the instructions, when executed by the memory system controller 315, may cause the controller to perform the operations of the process flow 500.

For example, the memory system controller 315 may determine at 505 whether a duration following a last access activity from a host system (e.g., the host system 205) coupled with the memory system has satisfied (e.g., is greater than or equal to) a threshold duration. If the memory system controller 315 determines that the duration fails to satisfy (e.g., lapse) the threshold duration, the memory system controller 315 may continue the access activity. If the memory system controller 315 determines that the duration satisfies the threshold duration (e.g., lapses the threshold duration), the memory system controller 315 may proceed to 510 to prepare for performing one or more refresh operations. In some examples, the memory system controller 315 may determine that the memory system is in an idle time in response to the determination that the duration satisfies the threshold duration.

At 510, the memory system controller 315 may enter an idle time, and may determine whether one or more data blocks are prioritized for refresh operations. For example, the memory system controller 315 may determine whether one or more data blocks are prioritized for a refresh operation in response to reading the stored one or more bits indicating that the third data was transferred to the one or more second destination data blocks according to the second set of parameters as described with reference to FIG. 4, where the one or more data blocks may represent the one or more second destination data blocks. If the memory system controller 315 determines that one or more data blocks are flagged for high priority refresh (e.g., by reading the one or more bits), the memory system controller 315 may proceed to 515 to perform a high priority refresh. In some examples, a high priority refresh may include refreshing the data blocks flagged for high priority refresh first before refreshing other blocks of the memory system according to a standard refresh procedure. In some examples, the memory system controller 315 may refrain from refreshing other data blocks except for the data blocks flagged for high priority refresh (e.g., the second destination data blocks containing the third data). In some cases, the memory system controller may read this indication from the one or more second destination data blocks or from another location of the memory system 310, such as an L2P table (e.g., associated with a first portion of the memory system 310, such as a TLC buffer).

In some examples, flagged blocks may include a portion of the third data. For example, as described with reference to FIG. 4, a portion of the third data may be written using a first programming speed, whereas the rest of the third data may be written using the second, faster write speed. Thus, the memory system controller 315 may flag blocks that contain data that were written using the second set of parameters (e.g., the faster write speed), and may thus perform a high priority refresh of the blocks containing the rest of the data and refrain from refreshing or perform a standard refresh on the blocks containing the portion of the third data. In some examples, the memory system controller 315 may prioritize writing memory cells using the first set of parameters to avoid additional refresh operations for high priory refresh.

If the memory system controller 315 determines that no data blocks are flagged for high priority refresh, the memory system controller 315 may proceed to 520 to perform a standard refresh. For example, a standard refresh may involve performing a refresh operation on all data blocks of the memory system 310, or on a portion of memory blocks of the memory system 310, where an order of the refresh operation may not be defined, or may be defined by an order that the memory blocks are arranged in the memory system 310. After performing the refresh procedures (standard or high priority), the memory system controller 315 may proceed to 525, where the refresh may be complete. In some examples, the memory system controller 315 may refrain from performing a refresh operation if no data blocks are flagged for high priority refresh.

In some examples, a data integrity of memory cells of the data blocks of the memory system 310 may be maintained while using the faster write speed due to high priority refresh operations. For example, by using the second set of parameters associated with the second, faster write speed, a data integrity of memory cells of written-to blocks may be compromised (e.g., may be associated with a less stable charge). Thus, by prioritizing data blocks, for example, that are written to using the second set of parameters, for refresh, the data of the blocks may be refreshed soon after folding to ensure data integrity equal to or greater than that of memory cells of blocks written to using the first set of parameters associated with the first, slower, write speed.

FIG. 6 illustrates a block diagram 600 of a memory system 620 that supports dynamic write speeds for data programming in accordance with examples as disclosed herein. The memory system 620 may be an example of aspects of a memory system as described with reference to FIGS. 1 through 5. The memory system 620, or various components thereof, may be an example of means for performing various aspects of dynamic write speeds for data programming as described herein. For example, the memory system 620 may include a data transfer component 625, a command component 630, a data write component 635, an indication storage component 640, a refresh component 645, or any combination thereof. Each of these components may communicate, directly or indirectly, with one another (e.g., via one or more buses).

The data transfer component 625 may be configured as or otherwise support a means for transferring first data from one or more first source data blocks of a first portion of a memory system to one or more first destination data blocks of a second portion of the memory system according to a first set of parameters used to write the first data to the one or more first destination data blocks, where the transfer of the first data is based at least in part on determining that a first quantity of unavailable source data blocks of the first portion of the memory system satisfies a first threshold. The command component 630 may be configured as or otherwise support a means for receiving, from a host system, one or more commands to write second data to the memory system. The data write component 635 may be configured as or otherwise support a means for writing the second data to one or more second source data blocks of the first portion of the memory system based at least in part on receiving the one or more commands. In some examples, the data transfer component 625 may be configured as or otherwise support a means for transferring third data from one or more third source data blocks of the first portion of the memory system to one or more second destination data blocks of the second portion of the memory system according to a second set of parameters used to write the third data to the one or more second destination data blocks, where the transfer of the third data is based at least in part on determining that a second quantity of unavailable source data blocks of the first portion of the memory system satisfies a second threshold, and where the second quantity of unavailable source data blocks is based at least in part on writing the second data.

In some examples, the indication storage component 640 may be configured as or otherwise support a means for storing one or more bits indicating that the third data was transferred to the one or more second destination data blocks of the memory system according to the second set of parameters used to write the third data to the one or more second destination data blocks.

In some examples, the refresh component 645 may be configured as or otherwise support a means for performing, based at least in part on determining that a duration following a last access activity from a host system coupled with the memory system has satisfied a threshold duration, a refresh operation of one or more data blocks of the memory system based at least in part on determining that the one or more data blocks are prioritized for the refresh operation, where determining that the one or more data blocks are prioritized for the refresh operation is based at least in part on reading the one or more bits indicating that the third data was transferred to the one or more second destination data blocks according to the second set of parameters, where the one or more data blocks includes the one or more second destination data blocks.

In some examples, the first set of parameters is associated with a first duration associated with writing each bit of the first data and the second set of parameters is associated with a second duration associated with writing each bit of the third data. In some examples, the second duration is less than the first duration.

In some examples, determining that the first quantity of unavailable source data blocks of the first portion of the memory system satisfies the first threshold includes determining that a first quantity of valid source data blocks of the first portion of the memory system satisfies a first threshold quantity of valid source data blocks, where the first quantity of unavailable source data blocks includes the first quantity of valid source data blocks and the first threshold includes the first threshold quantity of valid source data blocks, and determining that the second quantity of unavailable source data blocks of the first portion of the memory system satisfies the second threshold includes determining that a second quantity of valid source data blocks of the first portion of the memory system satisfies a second threshold quantity of valid source data blocks, where the second quantity of unavailable source data blocks includes the second quantity of valid source data blocks and the second threshold includes the second threshold quantity of valid source data blocks.

In some examples, determining that the first quantity of unavailable source data blocks of the first portion of the memory system satisfies the first threshold is based at least in part on determining that a first quantity of available addresses of a logical address space satisfies a first threshold quantity of addresses. In some examples, determining that the second quantity of unavailable source data blocks of the first portion of the memory system satisfies the second threshold is based at least in part on determining that a second quantity of available addresses of the logical address space satisfies a second threshold quantity of addresses.

In some examples, the data transfer component 625 may be configured as or otherwise support a means for transferring, after the transfer of the third data, fourth data from one or more fourth source data blocks of the first portion of the memory system to one or more third destination data blocks of the second portion of the memory system according to the first set of parameters based at least in part on determining that a third quantity of unavailable source data blocks of the first portion of the memory system satisfies the first threshold and fails to satisfy the second threshold.

In some examples, the data write component 635 may be configured as or otherwise support a means for writing the first data to the one or more first source data blocks of the first portion of the memory system, where writing the first data and the second data includes programming the first data and the second data to the one or more first source data blocks and the one or more second source data blocks using a single bit, a dual bit, or a triple bit programming operation.

In some examples, to support transferring the first data to the one or more first destination data blocks and the third data to the one or more second destination data blocks, the data transfer component 625 may be configured as or otherwise support a means for programming the first data to the one or more first destination data blocks and the third data to the one or more second destination data blocks using a quad-level programming operation.

FIG. 7 illustrates a flowchart showing a method 700 that supports dynamic write speeds for data programming in accordance with examples as disclosed herein. The operations of method 700 may be implemented by a memory system or its components as described herein. For example, the operations of method 700 may be performed by a memory system as described with reference to FIGS. 1 through 6. In some examples, a memory system may execute a set of instructions to control the functional elements of the device to perform the described functions. Additionally, or alternatively, the memory system may perform aspects of the described functions using special-purpose hardware.

At 705, the method may include transferring first data from one or more first source data blocks of a first portion of a memory system to one or more first destination data blocks of a second portion of the memory system according to a first set of parameters used to write the first data to the one or more first destination data blocks, where the transfer of the first data is based at least in part on determining that a first quantity of unavailable source data blocks of the first portion of the memory system satisfies a first threshold. The operations of 705 may be performed in accordance with examples as disclosed herein. In some examples, aspects of the operations of 705 may be performed by a data transfer component 625 as described with reference to FIG. 6.

At 710, the method may include receiving, from a host system, one or more commands to write second data to the memory system. The operations of 710 may be performed in accordance with examples as disclosed herein. In some examples, aspects of the operations of 710 may be performed by a command component 630 as described with reference to FIG. 6.

At 715, the method may include writing the second data to one or more second source data blocks of the first portion of the memory system based at least in part on receiving the one or more commands. The operations of 715 may be performed in accordance with examples as disclosed herein. In some examples, aspects of the operations of 715 may be performed by a data write component 635 as described with reference to FIG. 6.

At 720, the method may include transferring third data from one or more third source data blocks of the first portion of the memory system to one or more second destination data blocks of the second portion of the memory system according to a second set of parameters used to write the third data to the one or more second destination data blocks, where the transfer of the third data is based at least in part on determining that a second quantity of unavailable source data blocks of the first portion of the memory system satisfies a second threshold, and where the second quantity of unavailable source data blocks is based at least in part on writing the second data. The operations of 720 may be performed in accordance with examples as disclosed herein. In some examples, aspects of the operations of 720 may be performed by a data transfer component 625 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for transferring first data from one or more first source data blocks of a first portion of a memory system to one or more first destination data blocks of a second portion of the memory system according to a first set of parameters used to write the first data to the one or more first destination data blocks, where the transfer of the first data is based at least in part on determining that a first quantity of unavailable source data blocks of the first portion of the memory system satisfies a first threshold; receiving, from a host system, one or more commands to write second data to the memory system; writing the second data to one or more second source data blocks of the first portion of the memory system based at least in part on receiving the one or more commands; and transferring third data from one or more third source data blocks of the first portion of the memory system to one or more second destination data blocks of the second portion of the memory system according to a second set of parameters used to write the third data to the one or more second destination data blocks, where the transfer of the third data is based at least in part on determining that a second quantity of unavailable source data blocks of the first portion of the memory system satisfies a second threshold, and where the second quantity of unavailable source data blocks is based at least in part on writing the second data.

Aspect 2: The method, apparatus, or non-transitory computer-readable medium of aspect 1, further including operations, features, circuitry, logic, means, or instructions, or any combination thereof for storing one or more bits indicating that the third data was transferred to the one or more second destination data blocks of the memory system according to the second set of parameters used to write the third data to the one or more second destination data blocks.

Aspect 3: The method, apparatus, or non-transitory computer-readable medium of aspect 2, further including operations, features, circuitry, logic, means, or instructions, or any combination thereof for performing, based at least in part on determining that a duration following a last access activity from a host system coupled with the memory system has satisfied a threshold duration, a refresh operation of one or more data blocks of the memory system based at least in part on determining that the one or more data blocks are prioritized for the refresh operation, where determining that the one or more data blocks are prioritized for the refresh operation is based at least in part on reading the one or more bits indicating that the third data was transferred to the one or more second destination data blocks according to the second set of parameters, where the one or more data blocks includes the one or more second destination data blocks.

Aspect 4: The method, apparatus, or non-transitory computer-readable medium of any of aspects 1 through 3, where the first set of parameters is associated with a first duration associated with writing each bit of the first data and the second set of parameters is associated with a second duration associated with writing each bit of the third data and the second duration is less than the first duration.

Aspect 5: The method, apparatus, or non-transitory computer-readable medium of any of aspects 1 through 4, where determining that the first quantity of unavailable source data blocks of the first portion of the memory system satisfies the first threshold includes determining that a first quantity of valid source data blocks of the first portion of the memory system satisfies a first threshold quantity of valid source data blocks, where the first quantity of unavailable source data blocks includes the first quantity of valid source data blocks and the first threshold includes the first threshold quantity of valid source data blocks, and determining that the second quantity of unavailable source data blocks of the first portion of the memory system satisfies the second threshold includes determining that a second quantity of valid source data blocks of the first portion of the memory system satisfies a second threshold quantity of valid source data blocks, where the second quantity of unavailable source data blocks includes the second quantity of valid source data blocks and the second threshold includes the second threshold quantity of valid source data blocks.

Aspect 6: The method, apparatus, or non-transitory computer-readable medium of any of aspects 1 through 5, where determining that the first quantity of unavailable source data blocks of the first portion of the memory system satisfies the first threshold is based at least in part on determining that a first quantity of available addresses of a logical address space satisfies a first threshold quantity of addresses and determining that the second quantity of unavailable source data blocks of the first portion of the memory system satisfies the second threshold is based at least in part on determining that a second quantity of available addresses of the logical address space satisfies a second threshold quantity of addresses.

Aspect 7: The method, apparatus, or non-transitory computer-readable medium of any of aspects 1 through 6, further including operations, features, circuitry, logic, means, or instructions, or any combination thereof for transferring, after the transfer of the third data, fourth data from one or more fourth source data blocks of the first portion of the memory system to one or more third destination data blocks of the second portion of the memory system according to the first set of parameters based at least in part on determining that a third quantity of unavailable source data blocks of the first portion of the memory system satisfies the first threshold and fails to satisfy the second threshold.

Aspect 8: The method, apparatus, or non-transitory computer-readable medium of any of aspects 1 through 7, further including operations, features, circuitry, logic, means, or instructions, or any combination thereof for writing the first data to the one or more first source data blocks of the first portion of the memory system, where writing the first data and the second data includes programming the first data and the second data to the one or more first source data blocks and the one or more second source data blocks using a single bit, a dual bit, or a triple bit programming operation.

Aspect 9: The method, apparatus, or non-transitory computer-readable medium of aspect 8, where transferring the first data to the one or more first destination data blocks and the third data to the one or more second destination data blocks includes operations, features, circuitry, logic, means, or instructions, or any combination thereof for programming the first data to the one or more first destination data blocks and the third data to the one or more second destination data blocks using a quad-level programming operation.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over, as one or more instructions or code, a computer-readable medium. Other examples and implementations are within the scope of the disclosure and appended claims. For example, due to the nature of software, the described functions can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a memory device; and
a controller coupled with the memory device and configured to cause the apparatus to:
transfer first data from one or more first source data blocks of a first portion of a memory system to one or more first destination data blocks of a second portion of the memory system according to a first set of parameters used to write the first data to the one or more first destination data blocks, wherein the transfer of the first data is based at least in part on determining that a first quantity of unavailable source data blocks of the first portion of the memory system satisfies a first threshold;
receive, from a host system, one or more commands to write second data to the memory system;
write the second data to one or more second source data blocks of the first portion of the memory system based at least in part on receiving the one or more commands; and
transfer third data from one or more third source data blocks of the first portion of the memory system to one or more second destination data blocks of the second portion of the memory system according to a second set of parameters used to write the third data to the one or more second destination data blocks, wherein the transfer of the third data is based at least in part on determining that a second quantity of unavailable source data blocks of the first portion of the memory system satisfies a second threshold, and wherein the second quantity of unavailable source data blocks is based at least in part on writing the second data.

2. The apparatus of claim 1, wherein the controller is further configured to cause the apparatus to:
store one or more bits indicating that the third data was transferred to the one or more second destination data blocks of the memory system according to the second set of parameters used to write the third data to the one or more second destination data blocks.

3. The apparatus of claim 2, wherein the controller is further configured to cause the apparatus to:
perform, based at least in part on determining that a duration following a last access activity from a host system coupled with the memory system has satisfied a threshold duration, a refresh operation of one or more data blocks of the memory system based at least in part on determining that the one or more data blocks are prioritized for the refresh operation, wherein determining that the one or more data blocks are prioritized for the refresh operation is based at least in part on reading the one or more bits indicating that the third data was transferred to the one or more second destination data blocks according to the second set of parameters, wherein the one or more data blocks comprises the one or more second destination data blocks.

4. The apparatus of claim 1, wherein the first set of parameters is associated with a first duration associated with writing each bit of the first data and the second set of parameters is associated with a second duration associated with writing each bit of the third data, wherein the second duration is less than the first duration.

5. The apparatus of claim 1, wherein:
determining that the first quantity of unavailable source data blocks of the first portion of the memory system satisfies the first threshold comprises determining that a first quantity of valid source data blocks of the first portion of the memory system satisfies a first threshold quantity of valid source data blocks, wherein the first quantity of unavailable source data blocks comprises the first quantity of valid source data blocks and the first threshold comprises the first threshold quantity of valid source data blocks, and
determining that the second quantity of unavailable source data blocks of the first portion of the memory system satisfies the second threshold comprises determining that a second quantity of valid source data blocks of the first portion of the memory system satisfies a second threshold quantity of valid source data blocks, wherein the second quantity of unavailable source data blocks comprises the second quantity of valid source data blocks and the second threshold comprises the second threshold quantity of valid source data blocks.

6. The apparatus of claim 1, wherein:
determining that the first quantity of unavailable source data blocks of the first portion of the memory system satisfies the first threshold is based at least in part on determining that a first quantity of available addresses of a logical address space satisfies a first threshold quantity of addresses, and
determining that the second quantity of unavailable source data blocks of the first portion of the memory system satisfies the second threshold is based at least in part on determining that a second quantity of available addresses of the logical address space satisfies a second threshold quantity of addresses.

7. The apparatus of claim 1, wherein the controller is further configured to cause the apparatus to:
transfer, after the transfer of the third data, fourth data from one or more fourth source data blocks of the first portion of the memory system to one or more third destination data blocks of the second portion of the memory system according to the first set of parameters based at least in part on determining that a third quantity of unavailable source data blocks of the first portion of the memory system satisfies the first threshold and fails to satisfy the second threshold.

8. The apparatus of claim 1, wherein the controller is further configured to cause the apparatus to:
write the first data to the one or more first source data blocks of the first portion of the memory system, wherein writing the first data and the second data comprises programming the first data and the second data to the one or more first source data blocks and the one or more second source data blocks using a single bit, a dual bit, or a triple bit programming operation.

9. The apparatus of claim 8, wherein transferring the first data to the one or more first destination data blocks and the third data to the one or more second destination data blocks is configured to cause the apparatus to:
program the first data to the one or more first destination data blocks and the third data to the one or more second destination data blocks using a quad-level programming operation.

10. A non-transitory computer-readable medium storing code comprising instructions which, when executed by a processor of an electronic device, cause the electronic device to:
transfer first data from one or more first source data blocks of a first portion of a memory system to one or more first destination data blocks of a second portion of the memory system according to a first set of parameters used to write the first data to the one or more first destination data blocks, wherein the transfer of the first data is based at least in part on determining that a first quantity of unavailable source data blocks of the first portion of the memory system satisfies a first threshold;
receive, from a host system, one or more commands to write second data to the memory system;
write the second data to one or more second source data blocks of the first portion of the memory system based at least in part on receiving the one or more commands; and
transfer third data from one or more third source data blocks of the first portion of the memory system to one or more second destination data blocks of the second portion of the memory system according to a second set of parameters used to write the third data to the one or more second destination data blocks, wherein the transfer of the third data is based at least in part on determining that a second quantity of unavailable source data blocks of the first portion of the memory system satisfies a second threshold, and wherein the second quantity of unavailable source data blocks is based at least in part on writing the second data.

11. The non-transitory computer-readable medium of claim 10, wherein the instructions, when executed by the processor of the electronic device, further cause the electronic device to:
store one or more bits indicating that the third data was transferred to the one or more second destination data blocks of the memory system according to the second set of parameters used to write the third data to the one or more second destination data blocks.

12. The non-transitory computer-readable medium of claim 11, wherein the instructions, when executed by the processor of the electronic device, further cause the electronic device to:
perform, based at least in part on determining that a duration following a last access activity from a host system coupled with the memory system has satisfied a threshold duration, a refresh operation of one or more data blocks of the memory system based at least in part on determining that the one or more data blocks are prioritized for the refresh operation, wherein determining that the one or more data blocks are prioritized for the refresh operation is based at least in part on reading the one or more bits indicating that the third data was transferred to the one or more second destination data blocks according to the second set of parameters, wherein the one or more data blocks comprises the one or more second destination data blocks.

13. The non-transitory computer-readable medium of claim 10, wherein the first set of parameters is associated with a first duration associated with writing each bit of the first data and the second set of parameters is associated with a second duration associated with writing each bit of the third data, wherein the second duration is less than the first duration.

14. The non-transitory computer-readable medium of claim 10, wherein:
determining that the first quantity of unavailable source data blocks of the first portion of the memory system satisfies the first threshold comprises determining that a first quantity of valid source data blocks of the first portion of the memory system satisfies a first threshold quantity of valid source data blocks, wherein the first quantity of unavailable source data blocks comprises the first quantity of valid source data blocks and the first threshold comprises the first threshold quantity of valid source data blocks, and
determining that the second quantity of unavailable source data blocks of the first portion of the memory system satisfies the second threshold comprises determining that a second quantity of valid source data blocks of the first portion of the memory system satisfies a second threshold quantity of valid source data blocks, wherein the second quantity of unavailable source data blocks comprises the second quantity of valid source data blocks and the second threshold comprises the second threshold quantity of valid source data blocks.

15. The non-transitory computer-readable medium of claim 10, wherein:
determining that the first quantity of unavailable source data blocks of the first portion of the memory system satisfies the first threshold is based at least in part on determining that a first quantity of available addresses of a logical address space satisfies a first threshold quantity of addresses, and
determining that the second quantity of unavailable source data blocks of the first portion of the memory system satisfies the second threshold is based at least in part on determining that a second quantity of available addresses of the logical address space satisfies a second threshold quantity of addresses.

16. The non-transitory computer-readable medium of claim 10, wherein the instructions, when executed by the processor of the electronic device, further cause the electronic device to:
transfer, after the transfer of the third data, fourth data from one or more fourth source data blocks of the first portion of the memory system to one or more third destination data blocks of the second portion of the memory system according to the first set of parameters based at least in part on determining that a third quantity of unavailable source data blocks of the first portion of the memory system satisfies the first threshold and fails to satisfy the second threshold.

17. The non-transitory computer-readable medium of claim 10, wherein the instructions, when executed by the processor of the electronic device, further cause the electronic device to:
write the first data to the one or more first source data blocks of the first portion of the memory system, wherein writing the first data and the second data comprises programming the first data and the second data to the one or more first source data blocks and the one or more second source data blocks using a single bit, a dual bit, or a triple bit programming operation.

18. The non-transitory computer-readable medium of claim 17, wherein the instructions to transfer the first data to the one or more first destination data blocks and the third data to the one or more second destination data blocks, when executed by the processor of the electronic device, further cause the electronic device to:
program the first data to the one or more first destination data blocks and the third data to the one or more second destination data blocks using a quad-level programming operation.

19. A method, comprising:
transferring first data from one or more first source data blocks of a first portion of a memory system to one or more first destination data blocks of a second portion of the memory system according to a first set of parameters used to write the first data to the one or more first destination data blocks, wherein the transfer of the first data is based at least in part on determining that a first quantity of unavailable source data blocks of the first portion of the memory system satisfies a first threshold;
receiving, from a host system, one or more commands to write second data to the memory system;
writing the second data to one or more second source data blocks of the first portion of the memory system based at least in part on receiving the one or more commands; and
transferring third data from one or more third source data blocks of the first portion of the memory system to one or more second destination data blocks of the second portion of the memory system according to a second set of parameters used to write the third data to the one or more second destination data blocks, wherein the transfer of the third data is based at least in part on determining that a second quantity of unavailable source data blocks of the first portion of the memory system satisfies a second threshold, and wherein the second quantity of unavailable source data blocks is based at least in part on writing the second data.

20. The method of claim 19, further comprising:
storing one or more bits indicating that the third data was transferred to the one or more second destination data blocks of the memory system according to the second set of parameters used to write the third data to the one or more second destination data blocks.
